(19) United States
(12) Patent Application Publication
(10) Pub. No.: US 2026/0348346 A1
(43) Pub. Date: Nov. 5, 2026

(54) FUEL SYSTEM WITH INJECTOR AND DRAIN PASSAGE AND METHOD FOR LEAK MANAGEMENT

(71) Applicant: Caterpillar Inc., Peoria, IL (US)

(72) Inventors: Steven D. Wehri, Pontiac, IL (US); Eric L. Rogers, El Paso, IL (US); Christopher R. Jones, Washington, IL (US)

(73) Assignee: Caterpillar Inc., Peoria, IL (US)

(21) Appl. No.: 19/196,092

(22) Filed: May 1, 2025

(51) Int. Cl. F02M 55/00; F02M 63/00

(52) U.S. Cl. CPC F02M 55/002; F02M 55/008; F02M 63/0028; F02M 63/0054; F02M 2200/50

(57) ABSTRACT

A fuel system includes a fuel injector having a nozzle with a plurality of spray orifices formed therein, an injection valve movable to open and close the plurality of spray orifices, and a fuel plunger arranged to pressurize fuel in the fuel injector. The fuel injector forms an annulus circumferentially extending around the fuel plunger, and the fuel injector further forms a drain passage extending from the annulus. The fuel system further includes a non-return valve movable between a first position to block the annulus from the drain passage, and an open position. Related methodology is also disclosed.

### TECHNICAL FIELD

The present disclosure relates generally to a fuel system, and more particularly to a fuel injector with a drain passage for management of fuel leakage.

### BACKGROUND

Many modern internal combustion engines are fuel-injected, commonly direct-injected in compression-ignition engines. In a typical arrangement, a fuel injector is provided that extends partially into a combustion cylinder in an engine. The fuel injector is supplied with pressurized fuel, or pressurizes fuel therein, and injects the same at an injection pressure into the cylinder at a desired injection timing. The fuel is combusted with air to increase temperature and pressure in the cylinder and thereby drive a piston coupled to a crankshaft. Engines of this general type are used in a wide variety of applications ranging from powering vehicle powertrains to electric power generation.

Fuel injectors commonly include numerous small and rapidly moving parts, subjected to high fluid pressures, impacts, and otherwise generally harsh and repetitive operation over at least millions of operating cycles. Components of the fuel injector must be capable of withstanding fluid pressures commonly in the hundreds of mega-Pascals (MPa) for many applications. As a result, clearances between parts of the fuel injector can be prone to leakage, and fuel injectors are often designed to permit a certain degree of leakage. Factors such as fuel pressure, fuel type, and various regulatory requirements can affect whether and how much leakage is considered tolerable. One example mechanically actuated fuel injector is known from U.S. Pat. No. 9,822,744 B2 to Bimbenet et al.

### SUMMARY

In one aspect, a fuel system includes a fuel injector having a nozzle with a plurality of spray orifices formed therein, an injection valve movable to open and close the plurality of spray orifices, and a fuel plunger arranged to pressurize fuel in the fuel injector. The fuel injector forms an annulus circumferentially extending around the fuel plunger, and the fuel injector also forms a drain passage fluidly connected to the annulus. The fuel injector also includes a non-return valve movable between a first position to block the annulus from the drain passage, and an open position.

In another aspect, a fuel injector includes an injector housing having a nozzle with a plurality of spray orifices formed therein, and an injection valve movable to open and close the plurality of spray orifices. The fuel injector also includes a fuel plunger having a plunger body movable in a plunger cavity, and a plunger clearance is defined between the plunger body and the injector housing. An annulus circumferentially extends around the fuel plunger and fluidly connects to the plunger clearance. The fuel injector also includes a drain passage formed in the injector housing and extending from the annulus, and a non-return valve movable between a first position to block the annulus from the drain passage, and an open position.

In yet another aspect, operating a fuel system includes reciprocating a fuel plunger in a fuel injector in a plunger cavity in response to rotation of a cam, and leaking fuel through a leakage path fluidly connected to the plunger cavity. Operating the fuel system also includes collecting leaked fuel in an annulus extending around the fuel plunger, and draining at least some of the leaked fuel from the annulus into a drain passage in fluid communication with an oil supply. Operating the fuel system further includes urging a non-return valve between the annulus and the oil supply open via leaked fuel from the annulus.

### BRIEF DESCRIPTION OF DRAWINGS

FIG. 1 is a diagrammatic view of an internal combustion engine system, according to one embodiment;

FIG. 2 is a sectioned side diagrammatic view of a fuel injector, according to one embodiment; and

FIG. 3 is an enlarged sectioned diagrammatic view of a portion of a fuel injector, according to one embodiment.

### DETAILED DESCRIPTION

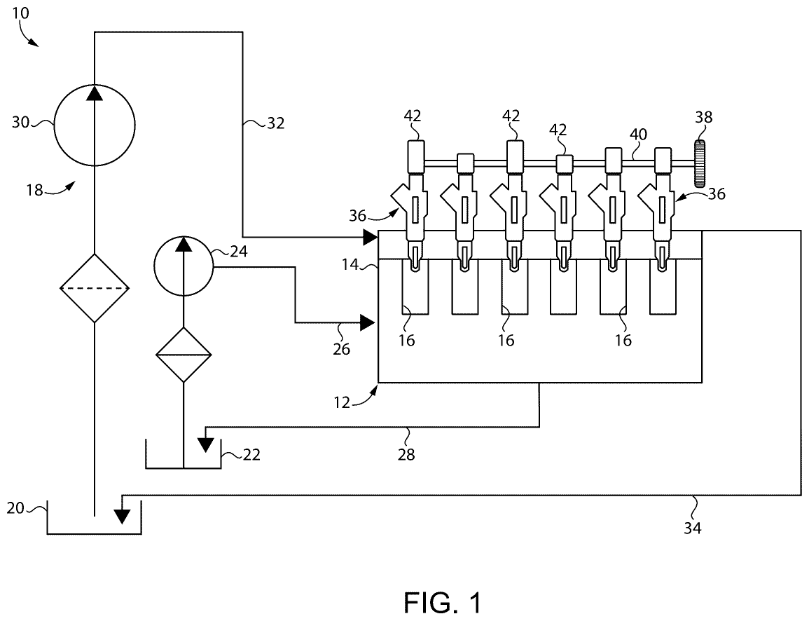

Referring to FIG. 1, there is shown an internal combustion engine system 10 (hereinafter “engine system 10”), according to one embodiment. Engine system 10 may be used in any known application, such as operating a driveline in a land vehicle or a marine vessel, operating a pump, a compressor, or an electrical generator to name a few examples. Engine system 10 includes an internal combustion engine 12 (hereinafter “engine 12”), having an engine housing 14 with a plurality of cylinders 16 formed therein. Engine system 10 can include any number of cylinders 16 in any suitable configuration, such as an inline arrangement, a V-pattern, or still another. It will be appreciated that a plurality of pistons will be positioned in cylinders 16 and typically each movable between a top-dead-center position and a bottom-dead-center position, in a four-stroke engine cycle in a generally conventional manner. Engine system 10 will typically be operated as a compression-ignition engine wherein pistons in cylinders 16 increase cylinder pressure and temperature to an auto-ignition threshold. However, the present disclosure is not limited to any particular ignition strategy.

Engine system 10 also includes a fuel system 18. Fuel system 18 may include at least one supply of a liquid fuel 20. Fuel supply 20 could include a compression-ignition fuel, such as a diesel distillate fuel, a lower cetane fuel blended with a cetane enhancer, or a variety of so-called alternative fuels such as bio-diesel, distillate diesel blended with bio-diesel or otherwise having some degree of bio-content, renewable fuels such as various seed oils, alcohol fuels such as methanol, ethanol, or various blends, for example. Fuel system 18 may be designed to selectively provide multiple fuels, including variable blend ratios in some embodiments.

Engine system 10 may further include an oil supply 22 for engine oil used in lubrication and cooling. Engine system 10 may also include an oil pump 24 connected to oil supply 22, mechanically or electrically driven to pressurize and circulate oil in engine 12. Engine system 10 may further include an oil conduit 26, which may be, for instance, an oil supply conduit 28, structured to convey oil at a pump outlet pressure from oil pump 24 to various engine components for lubrication and cooling. Oil conduit 26 could be formed within engine housing as a cast or machined channel, instance.

Fuel system 18 also includes at least one fuel pump 30 arranged to feed a liquid fuel from fuel supply 20 to engine housing 14 by way of a fuel supply conduit 32. A fuel return conduit 34 conveys fuel from engine housing 14 that is not injected for combustion back to fuel supply 20. Fuel system 18 may also include a plurality of direct fuel injectors 36. In some arrangements, fuel is conveyed through engine housing 14 to the plurality of direct fuel injectors 36. In other arrangements, fuel injectors 36 could be supplied with fuel in a so-called top feed arrangement such that fuel supply does not pass through engine housing 14. Arrangements where fuel injectors 36 include port injectors are also within the scope of the present disclosure.

Fuel injectors 36 may be mechanically actuated to pressurize the fuel to an injection pressure. To this end, engine system 10 further includes a cam gear 38 operated by way of an engine geartrain (not shown) and coupled to a camshaft 40. Camshaft 40 includes a plurality of cam lobes 42 that rotate in contact with fuel injectors 36 to actuate respective tappets as further discussed herein.

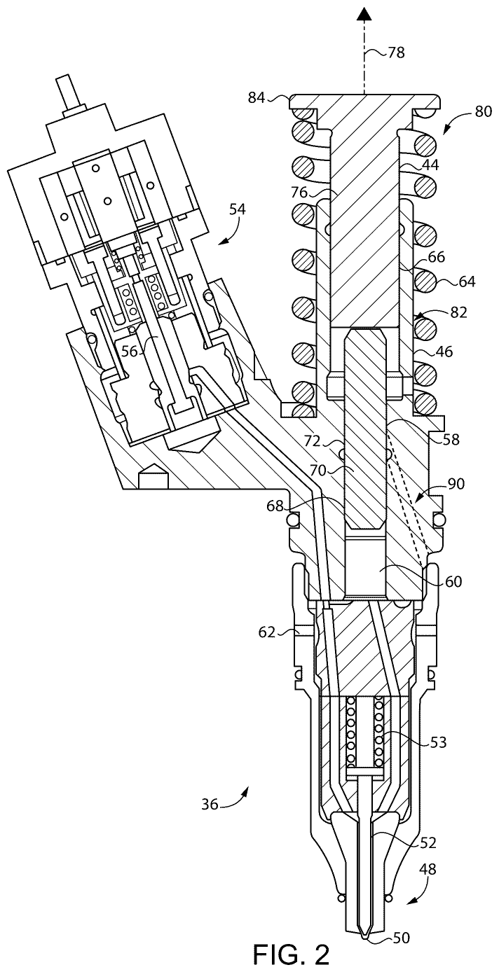

Referring also now to FIG. 2, there are shown features of an example one of fuel injectors 36, hereinafter referred to, at times, in the singular. Fuel injector 36 includes an injector housing 46 having a nozzle 48. Nozzle 48 extends into a corresponding cylinder 16 when fuel injector 36 is installed for service and includes a plurality of spray orifices 50 formed therein. Fuel injector 36 may further include an injection valve 52, such as a needle valve, movable to open and close spray orifices 50 in a generally conventional manner.

Fuel injector 36 may further include a spill valve assembly 54 having a spill valve 56. Spill valve 56 may be operated by way of an electrical actuator assembly (not numbered). In FIG. 2, spill valve 56 is shown partly within fuel injector 36, but it should be understood that placement of spill valve 56 may vary depending on packaging requirements or other factors, for instance, spill valve 56 may be external to fuel injector 36 and fluidly connected thereto, arranged as a “side car” approximately as shown, or integrated into the main portion of fuel injector 36 at least substantially coaxially with injection valve 52.

Fuel injector 36 may also include a fuel plunger 58 arranged to pressurize fuel in fuel injector 36. Spill valve assembly 54 may be operable in a generally known manner to selectively fluidly connect a plunger cavity 60 formed in injector housing 46 to a low-pressure fuel supply such as fuel supply conduit 32, and such that when spill valve 56 is closed advancing of fuel plunger 58 increases a pressure of fuel in plunger cavity 60 to an injection pressure. Put differently, spill valve 56 may be movable to vary a fluid connection between plunger cavity 60 and a low-pressure space to permit fuel plunger 58 to pressurize fuel when spill valve 56 is closed, and to passively draw fuel into and expel fuel from plunger cavity 60 when spill valve 56 is open.

Injector housing 46 also forms a low-pressure fuel inlet 62 that may be connected to fuel supply conduit 32. In some embodiments, reaching an injection pressure may cause opening hydraulic pressure on injection valve 52 to overcome an opposing force of a return spring 53 coupled to injection valve 52. When pressure decreases below an injection pressure, injection valve 52 is closed by the force of return spring 53. Start of injection and end of injection can be controlled by opening and closing spill valve to vary fuel injector 36 between the state where fuel plunger 58 is pressurizing fuel and the state where fuel is passively drawn in and out of plunger cavity 60. In other embodiments, injection valve 52 could be directly controlled by way of selective application of a closing hydraulic pressure thereon via an electrically actuated control valve.

Injector housing 46 may further form a tappet bore 66, within which tappet 44 may be reciprocally disposed. Tappet 44 may interface with fuel plunger 58, which may be axially aligned within a separate but coaxially arranged plunger bore 68. Tappet 44 and fuel plunger 58 may be in direct or indirect mechanical engagement in a generally conventional manner. Fuel plunger 58 may include a plunger body 70 movable in plunger cavity 60. A plunger clearance 72 may be defined between plunger body 70 and injector housing 46. Injector housing 46 may also form an annulus 74 circumferentially extending around fuel plunger 58. Annulus 74 is fluidly connected to plunger clearance 72.

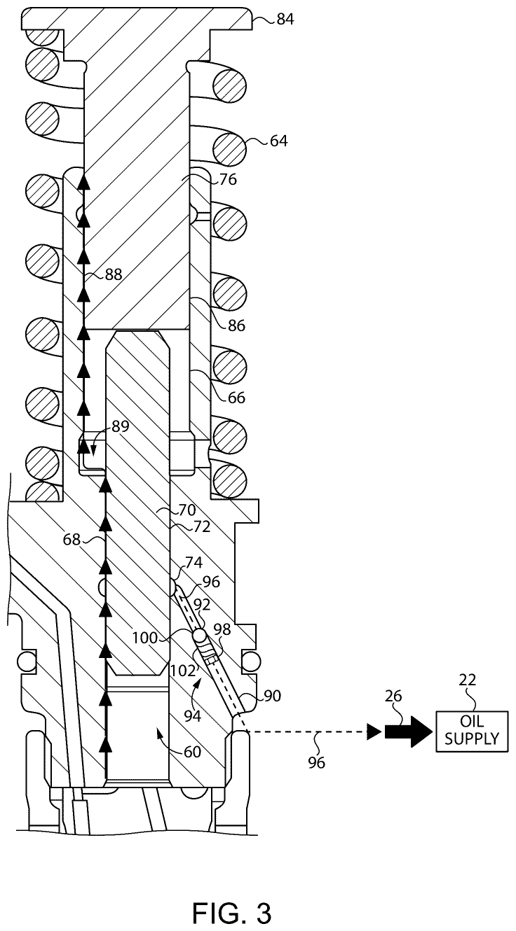

Referring also now to FIG. 3 there are shown additional features of fuel injector 36 in further detail. Tappet 44 may include a generally cylindrical tappet body 76 defining a longitudinal axis 78 extending from a first tappet end 80 to a second tappet end 82. First tappet end 80 may include an enlarged head 84 formed or affixed thereto. Enlarged head 84 may be structured to maintain continuous contact with cam lobe 42. Enlarged head 84 may have a greater outer diameter relative to tappet body 76 to increase a contact surface area. A return spring 64 may be concentrically positioned around tappet body 76, and may be utilized to act directly upon tappet 44 to provide an upward biasing force to restore tappet 44 to a retracted position following actuation.

A tappet clearance 86 may be defined between tappet 44 and injector housing 46. Tappet clearance 86 may be fluidly connected to annulus 74. Annulus 74 may be in fluid communication with tappet clearance 86 and plunger clearance 72 thereby defining a potential leakage path 88, advancing from plunger cavity 60.

Leakage path 88 may advance from annulus 74, through plunger clearance 72, and subsequently to tappet clearance 86, thereby forming a flow path that could theoretically carry leaked fuel and/or oil out of fuel injector 36. An inter-clearance cavity 89 may be defined between plunger clearance 72 and tappet clearance 86. Inter-clearance cavity 89 may fluidly connect the two clearances 72, 86 and may form a portion of leakage path 88. As will be further apparent from the forthcoming discussion, a draining mechanism may be utilized to limit or even eliminate migration of fuel through tappet clearance 86 and thus out of fuel injector 36.

Fuel injector 36 may also form a drain passage 90 for management of fuel leakage. Drain passage 90 may be directly fluidly connected to annulus 74 within injector housing 46, and thus also fluidly connected to leakage path 88. Drain passage 90 may also include a valve seat 92 therein. Valve seat 92 may be integrally formed in drain passage 90, or could be a discrete component positioned in drain passage 90, for example. In one example, valve seat 92 may be a conical valve seat. Valve seat 92 may be structured to cooperate with a corresponding non-return valve 94 located within drain passage 90. In other embodiments non-return valve 94 might be located outside of injector housing 46.

Non-return valve 94 may be movable between a first position to block annulus 74 from drain passage 90, and an open position. More particularly, non-return valve 94 may be structured to move away from valve seat 92 in response to an increased fuel pressure in fuel injector 36 to drain leaked fuel from leakage path 88 through drain passage 90. Drain passage 90 may also be fluidly connected to oil conduit 26, such that in the open position a drainage path 96 is defined through drain passage 90, from annulus 74 to oil conduit 26. When fuel injector 36 is at a sufficient internal pressure, such as during advancing plunger 70, leaked fuel may be urged out through drain passage 90. It should be understood that in the first position, non-return valve 94 also blocks oil flow from drain passage 90 to annulus 74. Thus, non-return valve permits leaked fuel to flow into drain passage 90 but prevents oil from being urged up into annulus 74. As a result, and in contrast to certain earlier strategies, during an off cycle of fuel injector 36, leaked fuel is not urged by oil pressure up into the portion of leakage path 88 formed by tappet clearance 66. In a practical example, oil conduit 26 may be structured to feed leaked fuel to an oil supply 22, such as oil supply conduit 28. In other embodiments, drain passage 88 could drain to a fuel supply or other low pressure space rather than to oil supply conduit 28.

In some embodiments, non-return valve 94 may be a spring-biased ball check valve 98 disposed in alignment with valve seat 92, and including a ball check element 100 and a spring element 102. Ball check element 100 may be spherical and fabricated from a metallic or ceramic material, for example, and can be biased by spring element 102 toward valve seat 92 to maintain a closed position.

As fuel plunger 58 translates within fuel injector 36, with spill valve 56 closed, an internal pressure in fuel injector 36 can begin to increase. As discussed herein, ball check 98 is normally closed and prevents ingress of oil. However, as the fuel pressure in fuel injector 36 continues to increase, the increased fuel pressure can overcome a closing bias of spring element 102. This permits leaked fuel to drain through drain passage 90. Once fuel pressure is reduced, such as by opening spill valve 56 at the end of a fuel injection, ball check element 100 can move back into contact with valve seat 92.

### INDUSTRIAL APPLICABILITY

In fuel injection systems, it is common for a portion of fuel to escape from the fuel injector during operation and potentially make its way into the engine's oil system. This is particularly common due to the high pressures involved in fuel injection in many systems. As suggested above, incident oil pressure at locations in a leakage path or a potential leakage path can compound challenges around managing fuel leakage. In a fuel injector such as fuel injector 36 engine oil pressure supplied to leakage path 88 could have a tendency to urge leaked fuel up through the portions of leakage path formed around tappet 44. During an off cycle of fuel injector 36 when spill valve 56 is open and fuel is not being pressurized, non-return valve 94 can block oil pressure from annulus 74, thus from leakage path 88, and limit or eliminate any fuel leakage that might otherwise occur.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel system comprising:
a fuel injector including a nozzle having a plurality of spray orifices formed therein, an injection valve movable to open and close the plurality of spray orifices, and a fuel plunger arranged to pressurize fuel in the fuel injector;
the fuel injector forming an annulus circumferentially extending around the fuel plunger;
the fuel injector further forming a drain passage fluidly connected to the annulus; and
a non-return valve movable between a first position to block the annulus from the drain passage, and an open position.

2. The fuel system of claim 1 further including an oil conduit, and the drain passage is connected to the oil conduit.

3. The fuel system of claim 2 further comprising an engine housing, and wherein the oil conduit is formed in the engine housing.

4. The fuel system of claim 2 wherein the fuel injector includes an injector housing defining the annulus and the drain passage, and the drain passage is directly fluidly connected to the annulus within the injector housing.

5. The fuel system of claim 4 wherein a plunger cavity and a plunger clearance, defined between the fuel plunger and the injector housing, are formed in the fuel injector, and the plunger clearance fluidly connects the plunger cavity to the annulus.

6. The fuel system of claim 5 further including a tappet in contact with the fuel plunger.

7. The fuel system of claim 6 wherein the fuel injector defines a tappet clearance between the tappet and the injector housing, and the plunger clearance, the tappet clearance, and the annulus form a leakage path.

8. The fuel system of claim 2 further including a valve seat formed in the drain passage, and wherein the non-return valve is within the fuel injector and in the first position contacts the valve seat to block oil flow from the drain passage to the annulus.

9. The fuel system of claim 8 wherein the non-return valve moves away from the valve seat in response to an increased pressure in the fuel injector to drain leaked fuel through the drain passage.

10. The fuel system of claim 9 wherein the non-return valve includes a ball check, and a biasing spring biasing the ball check into contact with the valve seat.

11. A fuel injector comprising:
an injector housing including a nozzle having a plurality of spray orifices formed therein, and an injection valve movable to open and close the plurality of spray orifices;
a fuel plunger including a plunger body movable in a plunger cavity, and a plunger clearance is defined between the plunger body and the injector housing;
an annulus circumferentially extending around the fuel plunger and fluidly connected to the plunger clearance;
a drain passage formed in the injector housing and extending from the annulus; and
a non-return valve movable between a first position to block the annulus from the drain passage, and an open position.

12. The fuel injector of claim 11 further including a valve seat formed in the drain passage, and a biaser biasing the non-return valve into contact with the valve seat.

13. The fuel injector of claim 12 wherein the non-return valve is movable to the open position in response to an increased pressure in the fuel injector.

14. The fuel injector of claim 11 wherein the non-return valve includes a spring-biased ball check.

15. The fuel injector of claim 11 further including a tappet in contact with the fuel plunger, and a tappet clearance is defined between the tappet and the injector housing and fluidly connected to the annulus.

16. The fuel injector of claim 15 wherein the plunger clearance, the tappet clearance, and the annulus form a leakage path.

17. A method of operating a fuel system comprising:
reciprocating a fuel plunger in a fuel injector in a plunger cavity in response to rotation of a cam;
leaking fuel through a leakage path fluidly connected to the plunger cavity;
collecting leaked fuel in an annulus extending around the fuel plunger;
draining at least some of the leaked fuel from the annulus into a drain passage in fluid communication with an oil supply; and
urging a non-return valve between the annulus and the oil supply open via leaked fuel from the annulus.

18. The method of claim 17 further comprising urging the non-return valve closed via oil from the oil supply.

19. The method of claim 17 wherein the non-return valve includes a spring-biased ball check biased to a closed position limiting a flow of oil to the annulus.
